(19) United States
(12) Patent Application Publication
(10) Pub. No.: US 2024/0318719 A1
(43) Pub. Date: Sep. 26, 2024

(54) Blocking Mechanism, Electric Motor Drive Unit, and Method for Blocking a Shaft of a Drivertrain

(71) Applicant: Vitesco Technologies GmbH, Regensburg (DE)

(72) Inventors: Christof Heeger, Gelnhausen (DE); Karl Martin Fritsch, Frankfurt (DE)

(73) Assignee: Vitesco Technologies GmbH, Regensburg (DE)

(21) Appl. No.: 18/680,045

(22) Filed: May 31, 2024

Related U.S. Application Data
(63) Continuation of application No. PCT/EP2022/083900, filed on Nov. 30, 2022.

(30) Foreign Application Priority Data
Dec. 2, 2021 (DE) 10 2021 213 739.3

(51) Int. Cl. F16H 63/34; F16H 63/36; H02K 7/10

(52) U.S. Cl. CPC F16H 63/3441; F16H 63/3458; F16H 63/36; H02K 7/10

(57) ABSTRACT

The disclosure relates to a blocking mechanism, such as of a vehicle. A form-fitting element positioned between a blocking actuator and a blockable shaft of a drivetrain. The form fitting element can be actuated in an axial stroke movement and longitudinally in relation to the shaft, and, in a state in which the form-fitting element bears against an end face of a shaft-mounted complement to which the form-fitting element can be partially form-fittingly coupled and be biased longitudinally in relation to the shaft and in defined fashion against the shaft-mounted complement by way of at least one elastic force transmission portion so as to be able to enter a latching engagement.

### CROSS-REFERENCE TO RELATED APPLICATIONS

This application claims the benefit of PCT Application PCT/EP2022/083900, filed Nov. 30, 2022, which claims priority to German Application 10 2021 213 739.3, filed Dec. 2, 2021. The disclosures of the above applications are incorporated herein by reference.

### TECHNICAL FIELD

The disclosure relates to a blocking mechanism, an electric motor drive unit, a vehicle, and a method for blocking a shaft of a drivetrain.

### SUMMARY

The disclosure provides an improved blocking mechanism for a vehicle. The blocking mechanism, for example used in a vehicle or a parking lock of a vehicle, includes a form-fitting element actuating between a blocking actuator and a blockable shaft of a drivetrain. The form-fitting element, which can be actuated in an axial stroke movement and longitudinally in relation to the shaft, can be at least partially form-fittingly coupled to a shaft-mounted complement within a form-fitting region to block the shaft, and, in a state in which it bears against the end face of the shaft-mounted complement, can be biased longitudinally in relation to the shaft against the shaft-mounted complement by at least one elastic force transmission portion in defined fashion and so as to be able to enter a latching engagement.

The at least one elastic force transmission portion is advantageously integrated in the form-fitting element. That is to say, the at least one elastic force transmission portion is formed or designed in one piece with the form-fitting element.

In a blocked state of the shaft, in which the form-fitting element and the shaft-mounted complement engage in one another in the form-fitting region of the blocking mechanism, the form-fitting element is supported against a housing portion of an electric motor drive unit, on which the blocking actuator is mounted.

In the form-fitting region and in the circumferential direction of the shaft, the blocking mechanism has a movement clearance between the form-fitting element and the shaft-mounted complement, this movement clearance, in combination with said or the aforementioned bias of the form-fitting element against the shaft-mounted complement, making it possible to latch the form-fitting element into the shaft-mounted complement or to couple the form-fitting element to the shaft-mounted complement.

In this case, a shaft-mounted complement is understood to mean a shaft-mounted mating piece with respect to the form-fitting element, this mating piece has a correspondingly complementary form or shape to the form-fitting element in the form-fitting region. The complement may be a correspondingly shaped portion of the shaft itself or a separate and correspondingly shaped element which is coupled to the shaft and form-fittingly interacts with the form-fitting element.

Here, an elastic force transmission portion is a mechanical energy store for elastically biasing the form-fitting element against the shaft-mounted complement, specifically in the form of at last one spring element portion integrated in the form-fitting element.

This energy store biases the form-fitting element against the shaft-mounted complement until the shaft assumes or reaches a suitable alignment, relative to the form-fitting element, for a form fit. As soon as such an alignment exists, this energy store presses the form-fitting element into the shaft-mounted complement to produce a latching engagement, with the result that the shaft is blocked.

The proposed blocking mechanism enables a compact and inexpensive design, which saves on installation space, within a drivetrain, supported by a vehicle.

Moreover, the proposed blocking mechanism can be implemented in a way which saves on energy, since it is not necessary for the actuator to apply any high adjustment forces for said biasing. When the form-fitting element is coupled to the shaft-mounted complement, specifically only the form-fitting element, and not also the element to be blocked of a drivetrain, is moved.

In some examples, the shaft-mounted complement is arranged in the region of an end of the shaft. The blocking actuator may be mounted on the housing portion in a manner situated opposite the end of the shaft.

In some implementations, the form-fitting element is moreover arranged coaxially with the shaft. This provides a compact design of an electric motor drive unit, for a vehicle, that has such a blocking mechanism.

The form-fitting element may be shaped in the form of an annular element that runs around in closed manner and advantageously may be arranged coaxially with the blockable shaft.

The form-fitting element has an inner profiling which form-fittingly interacts with a profiling, complementary to the inner profiling, of the shaft-mounted complement in the form-fitting region.

The form-fitting element also has an outer profiling which has a complementary shape to a guide portion. This guide portion may be a portion of the blocking actuator itself, which is mounted on or fastened to the housing portion. As an alternative to this, the guide portion may be shaped on or integrated in the housing portion itself. This guide portion longitudinally guides the form-fitting element for the axial stroke movement in relation to the shaft. Therefore, the form-fitting element—depending on the implementation of this guide portion—is indirectly or directly supported on the housing portion.

In some examples, the form-fitting element is supported against a housing portion of an electric motor housing or of a (reduction) gear housing. The blocking mechanism is advantageously integrated in the electric motor housing or (reduction) gear housing.

The form-fitting element may have an electrically actuatable design.

The form-fitting element is attached to a movement mechanism of the blocking actuator via the at least one elastic force transmission portion or the at least one mechanical energy store, which movement mechanism brings about the axial stroke movement of the form-fitting element.

The movement mechanism may have a screw drive for generating the axial stroke movement.

In some implementations, this screw drive at the same time advantageously acts like a bearing point, which faces toward the blockable shaft and receives a rotor shaft of an electric motor. The nut, or threaded nut, of the screw drive is also integrated in the form-fitting element, specifically in the form of a hub portion of the form-fitting element. This functional integration additionally promotes miniaturization of the blocking actuator and thus of the blocking mechanism.

As an alternative to this, the movement mechanism may have a plunger coil for generating the axial stroke movement.

Another aspect of the disclosure provides an electric motor drive unit having a blocking mechanism of the type described above.

Yet another aspect of the disclosure provides a vehicle having such an electric motor drive unit or a blocking mechanism of the type described above.

A vehicle is to be understood to mean any type of vehicle or motor vehicle that is operated by an electric motor, but in particular passenger motor cars and/or utility vehicles. These may be partially autonomously and for example fully autonomously operated vehicles.

Yet another aspect of the disclosure provides a method for blocking a shaft of a drivetrain, such as of a vehicle, by way of a blocking mechanism of the type described above.

During the execution of the method, the form-fitting element is brought into latching engagement with the shaft-mounted complement, utilizing the movement clearance, up to a maximum rotational speed of the shaft that depends on the movement clearance, in that the form-fitting element, in a state in which it bears against an end face of the shaft-mounted complement, is biased longitudinally in relation to the shaft and with a definable force against the shaft-mounted complement via the at least one elastic force transmission portion until a latching engagement is obtained.

In some implementations, if the vehicle starts to move from a stationary position, a shaft of the vehicle is blocked up to a maximum speed of the vehicle that depends on the movement clearance.

The blocking actuator needs to apply only a relatively small force for biasing purposes. The applied biasing force needs only to be great enough that it brings the form-fitting element—utilizing the movement clearance—into a force fit with the shaft-mounted complement in an available period of time that depends on a rotational speed of the shaft or vehicle speed.

In some examples, only the form-fitting element of the blocking actuator, and not also the shaft to be blocked of the drivetrain, is moved.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary blocking mechanism in a planar sectional illustration;

FIG. 2 shows a form-fitting region of the exemplary blocking mechanism; and

FIG. 3 shows an electric motor drive unit of a drivetrain.

Like reference symbols in the various drawings indicate like elements.

### DETAILED DESCRIPTION

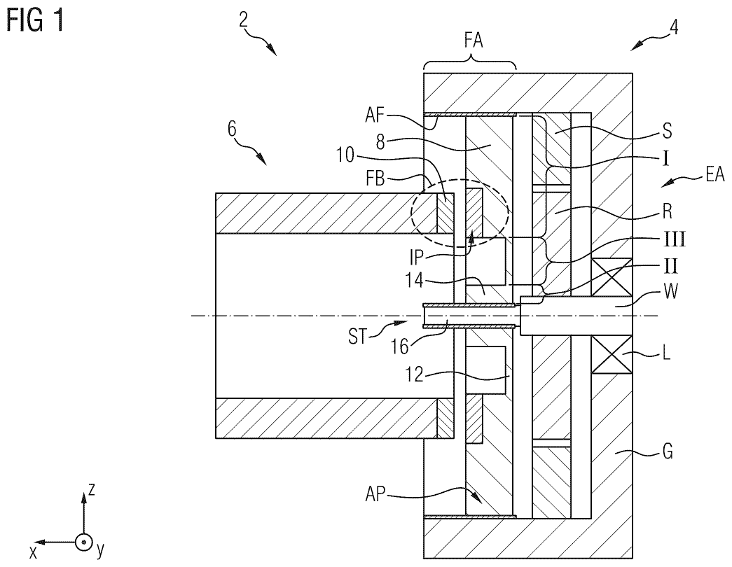

FIG. 1 depicts a blocking mechanism 2, in the case of which a blocking actuator 4 interacts with a blockable shaft 6, for instance in the form of a hollow shaft of a drivetrain.

The blocking actuator 4 includes a form-fitting element 8, which is electrically actuatable in an axial stroke movement in the longitudinal direction X-X and longitudinally in relation to the shaft 6.

FIG. 1 shows this form-fitting element 8 in a state in which it is not coupled to the shaft 6. The shaft 6 is therefore not depicted in the blocked state.

In a blocked state of the shaft 6, the form-fitting element 8 and the shaft 6 are operatively connected to one another in a form-fitting region FB, or partially form-fittingly engage in one another in this form-fitting region FB, with the result that the shaft 6 is blocked.

The form-fitting element 8 is shaped in the form of an element which runs around at least partially in closed manner and form-fittingly interacts with an end face of a shaft-mounted complement via an inner profiling IP.

This inner profiling IP is formed by an annular arrangement of axially outwardly and inwardly projecting bar- or tooth- or claw-like form-fitting elements, which are distributed at regular intervals in the circumferential direction of the form-fitting element 8, face toward the shaft 6, form a type of inner profiling IP of the form-fitting element 8 and can be brought into a form fit with the shaft-mounted complement in the form-fitting region FB.

The shaft-mounted complement is shaped in or on the shaft 6 itself in a region of that end of the shaft 6 that faces toward the blocking actuator 4, specifically in the form of a shaft outer profiling 10 with a complementary shaping to the inner profiling IP.

The form-fitting element 8 and the shaft 6 engage form-fittingly in one another similar to a spur gear toothing.

In its radial extent, or in the transverse direction Y-Y or Z-Z, the form-fitting element 8 is subdivided into three portions, namely a first, outer portion I, which has the inner profiling IP on the end face and toward the shaft 6, a second, inner portion II in the form of a hub portion 14 or hub-like portion 14, and a third portion III in the form of an axially elastic spring element portion 12 which acts in the longitudinal direction X-X of the shaft 6, functions like a mechanically elastic energy store, and is shaped between the first portion I and the second portion II. This third portion III may be shaped, for example, so as to run around in continuous or closed fashion in the circumferential direction of the form-fitting element 8. As an alternative to this, this third portion III may have a multiplicity of bar-like portions, which are at regular spacings from one another in the circumferential direction of the form-fitting element 8 and via which an appropriate axially elastic action of this portion III can be implemented or realized.

For the axial stroke movement in the longitudinal direction X-X, the form-fitting element 8 is guided by way of an axial guide AF within a guide portion FA.

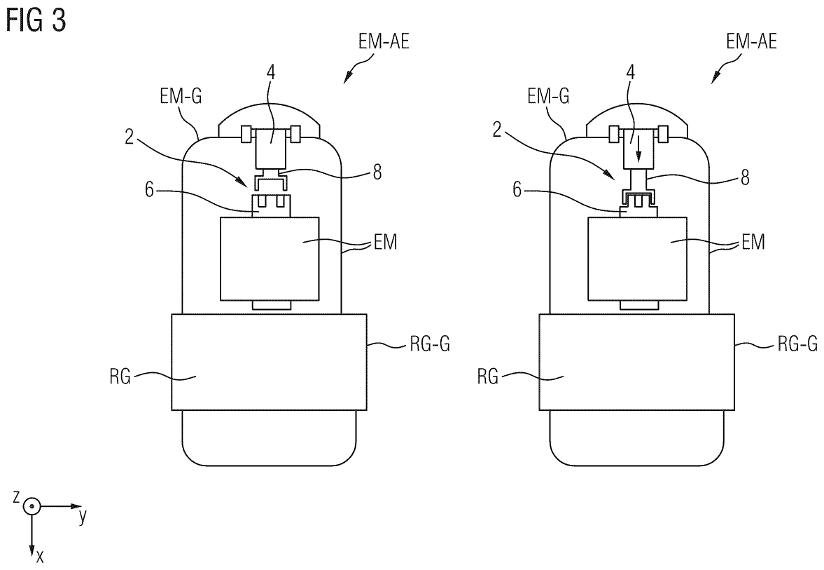

In some implementations, this guide portion FA is integrated in the blocking actuator 4 or is in the form of a portion of the blocking actuator 4 and as such is mounted, for example, on a housing portion EM-G of an electric motor EM of an electric motor drive unit EM-AE (see FIG. 3). In the blocked state of the shaft 6, the form-fitting element 8 is supported against the housing portion EM-G of the electric motor EM via this guide portion FA. In the blocked state of the shaft 6, therefore, both static and dynamic torque loads of the drivetrain are introduced into the housing portion or the housing EM-G of the electric motor EM via this guide portion FA.

In some examples, the form-fitting element 8 is guided longitudinally in relation to the shaft 6 or in its longitudinal direction X-X, via for example three radially outwardly projecting, claw-like form-fitting elements which are at a regular spacing from one another and are integrally molded or shaped on the outer circumference of the guide element, in the guide portion FA that is integrally molded or shaped in corresponding or complementary fashion to these form-fitting elements. These claw-like form-fitting elements form an outer profiling of the form-fitting element 8.

FIG. 3 depicts such an electric motor drive unit EM-AE of a drivetrain, i.e., of a vehicle, which has the electric motor EM, a reduction gear RG and the blocking mechanism 2.

The blocking actuator 4 is arranged opposite the end of the shaft 6 and coaxially with the shaft and is mounted on the housing portion EM-G of the electric motor EM (see also FIG. 1). The proposed blocking mechanism 2 is thus advantageously integrated in the electric motor EM. The blocking actuator 4 is integrated in the electric motor housing EM-G. As regards the aforementioned vehicle, FIG. 3 thus depicts a parking lock integrated in the electric motor EM.

Via the axially elastic spring element portion 12 (mechanical energy store), which—as already explained above—may be formed by one element or multiple elements of said third portion III of the form-fitting element 8, the form-fitting element 8 can be attached to an electric drive EA of the blocking actuator 4 elastically in the longitudinal direction X-X.

This spring element portion 12 (portion III) is an integral part of the form-fitting element 8. This spring element portion 12 (portion III) may also be injection molded onto the first portion I and second portion II of the form-fitting element 8 and thus materially bonded to the first portion I and second portion II of the form-fitting element 8.

In some examples, the entire form-fitting element 8, in addition to the spring element portion 12, may be shaped from a plastic or formed from such a plastic by plastics injection molding.

This functional integration advantageously promotes miniaturization of the blocking actuator 4 and thus of the blocking mechanism 2.

The electric drive EA of the blocking actuator 4 has a stator S, which drives a rotor R lying inside it by way of permanent magnets. Via a rotor shaft W, the rotor R is received on the housing, or at that end of the rotor shaft W that faces away from the shaft 6, in a conventional bearing L, for instance in the form of a roller bearing.

By contrast, on the shaft side, or at that end of the rotor shaft W that faces toward the shaft 6, the rotor shaft W is connected to a threaded spindle 16 or provided with a threaded-spindle portion 16, which forms a screw drive ST in combination with the hub portion 14 of the form-fitting element 8. The hub portion 14 is in the form of a nut or threaded nut of the screw drive ST. This nut is accordingly likewise integrated in the form-fitting element 8 or an integral part of the form-fitting element 8.

This functional integration also advantageously contributes to miniaturization of the blocking actuator 4 and thus of the blocking mechanism 2.

No conventional bearing for receiving the rotor shaft W is provided on the shaft side, or at that end of the rotor shaft W that faces toward the shaft 6. Instead, on the shaft side, the screw drive ST receives or mounts the rotor shaft W. This omission of a conventional bearing likewise contributes to miniaturization of the blocking actuator 4 and thus of the blocking mechanism 2.

The form-fitting element 8 accordingly can be moved relative to the shaft end along the threaded spindle 16, with which the hub portion 14 interacts, in the longitudinal direction X-X, depending on the direction of rotation of the rotor shaft W or of the threaded spindle 16 connected to it (rotating counterclockwise or clockwise). This screw drive ST converts a rotational movement of the rotor R into an axial movement (or translational movement) of the form-fitting element 8 in the longitudinal direction X-X.

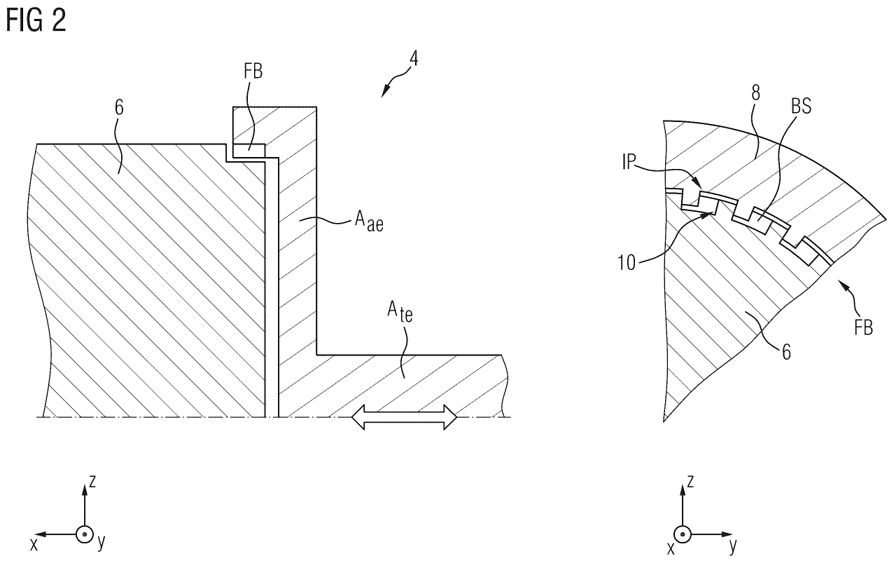

FIG. 2 purely schematically depicts the operative connection between the blocking actuator 4 and the shaft 6. The blocking actuator 4 has a portion Aₐₑ which is axially elastic in the longitudinal direction X-X and a torsionally elastic or torsionally flexible portion Aₜₑ auf.

With reference to FIG. 1, this axially elastic portion Aₐₑ is implemented or realized by the spring element portion 12 (or energy store), whereas the torsionally elastic or torsionally flexible portion Aₜₑ is implemented or realized by the hub portion 14.

Axial impact loadings or impacts in the longitudinal direction X-X in connection with the coupling operation can be reduced via this axially elastic energy store 12.

Dynamic—and design-relevant—torque loads in the form of torque peaks of a drivetrain are expressed with respect to the blocking mechanism 2 in the form of impact loadings in the transverse direction Y-Y or Z-Z, which act on the blocking actuator 4 or its form-fitting element 8.

A dynamic torque load is understood to mean a short-term torque load which can result, for example, if a vehicle impacts a parked vehicle. In such an event, a force acting externally on the vehicle generates such a short-term, dynamic torque in the drivetrain of the motor vehicle. At this juncture, reference is also made, for example, to a design-relevant, dynamic torque load in the event of a fault, which is described in more detail below.

A torsionally flexible hub portion 14 makes it possible to advantageously reduce these impact loadings on the form-fitting element 8 in the transverse direction Y-Y or Z-Z. A torsionally flexible design thus additionally promotes the miniaturization of the blocking actuator 4 and thus of the blocking mechanism 2.

FIG. 2 also depicts the form-fitting region FB between the form-fitting element 8 and the shaft 6 and also a movement clearance BS, which is the basis for this form-fitting region FB, between the inner profiling IP of the form-fitting element 8 and the shaft-mounted profiling or shaft outer profiling 10, specifically in the circumferential direction of the shaft 6.

This movement clearance BS makes it possible to block the shaft 6 using the form-fitting element 8 as soon as the shaft 6 reaches a corresponding alignment relative to the form-fitting element 8, which is required for a form fit or coupling of the elements 6, 8 to be coupled.

In connection with the aforementioned vehicle, this means that the vehicle can be blocked, for instance at the driver's request, in a parked situation in which the vehicle is stationary.

Provided that the alignment of the shaft 6 is not such in this parked situation that it enables the blocking by the form-fitting element 8, the form-fitting element 8, in a state in which it bears against the end face of the shaft 6, can be biased longitudinally in relation to the shaft 6 and with a definable force against the shaft 6 via this spring element portion 12 to form a latching engagement. If the shaft 6 is subsequently turned or rotated only somewhat further, the form-fitting element 8 enters a latching engagement with the shaft 6 as soon as an alignment of the shaft 6 which enables the latching engagement is reached. Such a further rotation (turn) of the shaft 6 in the parked situation can be permitted by the vehicle system.

However, the movement clearance BS also enables the following emergency scenario in the event of a fault during which the electric motor EM of the electric motor drive unit EM-AE fails.

If, in the case of the aforementioned vehicle while it is being driven, the electric motor EM of the electric motor drive unit EM-AE fails and the vehicle is then braked on a road with an incline until it is stationary, then the blocking mechanism 2 described above makes it possible to block the vehicle if it then starts to move from the stationary position, specifically up to a maximum rotational speed of the shaft 6 or maximum speed of the vehicle that depends on the movement clearance BS.

The form-fitting element 8 is brought into latching engagement with the shaft 6 utilizing the movement clearance BS and up to the maximum rotational speed of the shaft 6 or maximum speed of the vehicle that depends on the movement clearance BS, in that the form-fitting element 8, in a state in which it bears against an end face of the shaft 6, is biased longitudinally in relation to the shaft 6 and with a definable force against the shaft 6 via this spring element portion 12 until a latching engagement is obtained. Lastly, the latching engagement is effected as soon as the shaft 6 reaches a corresponding alignment in relation to the form-fitting element 8.

It should be noted that numerous modifications to the explained examples are possible. It should be noted, furthermore, that the describes implementations are merely examples which are in no way intended to limit the scope of protection, the applications, and the structure. Instead, the above description gives a person skilled in the art a guideline for the implementation of at least one exemplary embodiment, it being possible to make various changes, especially with regard to the function and arrangement of the component parts described, without departing from the scope of protection as emerges from the claims and combinations of features that are equivalent thereto.

What is claimed is:

1. A blocking mechanism for a vehicle, the blocking mechanism comprising:
a blocking actuator of a drivetrain of the vehicle;
a blockable shaft of the drivetrain; and
a form-fitting element being part of the blocking actuator and actuating between the blocking actuator and the blockable shaft, the form-fitting element is actuated in an axial stroke movement and longitudinally in relation to the blockable shaft, the form-fitting element includes an elastic force transmission portion being integrated in the form-fitting element, wherein:
in a state where the form-fitting element bears against an end face of a shaft-mounted complement to which the form-fitting element is partially form-fittingly coupled, the form-fitting element is biased longitudinally in relation to the blockable shaft and in defined manner against the shaft-mounted complement by at least one elastic force transmission portion to form a latching engagement, and
in a blocked state of the blockable shaft where the form-fitting element and the shaft-mounted complement engage in one another in a form-fitting region of the blocking mechanism, the form-fitting element is supported against a housing portion of an electric motor drive unit, the blocking actuator is mounted on the housing portion, and in the form-fitting region and in a circumferential direction of the blockable shaft, the blocking mechanism has a movement clearance between the form-fitting element and the shaft-mounted complement.

2. The blocking mechanism of claim 1, wherein the shaft-mounted complement is arranged in a region of an end of the blockable shaft.

3. The blocking mechanism of claim 2, wherein the blocking actuator is mounted on the housing portion in a manner situated opposite the end of the blockable shaft.

4. The blocking mechanism of claim 3, the form-fitting element being arranged coaxially with the blockable shaft.

5. The blocking mechanism of claim 1, wherein the form-fitting element is shaped in a form of an annular element that runs around in closed fashion.

6. The blocking mechanism of claim 1, wherein the form-fitting element has an inner profiling which form-fittingly interacts with a complementary profiling of the shaft-mounted complement in the form-fitting region.

7. The blocking mechanism of claim 1, wherein the form-fitting element has an outer profiling which is complementary to a guide portion of the blocking actuator or of the housing portion, via which guide portion the form-fitting element is longitudinally guided for the axial stroke movement and via which guide portion the form-fitting element is indirectly or directly supported against the housing portion.

8. The blocking mechanism of claim 1, wherein the form-fitting element is supported against a housing portion of an electric motor housing or of a gear housing.

9. The blocking mechanism of claim 1, wherein the form-fitting element is electrically actuatable.

10. The blocking mechanism of claim 1, wherein the form-fitting element is attached to a movement mechanism of the blocking actuator via the at least one elastic force transmission portion, the movement mechanism brings about the axial stroke movement of the form-fitting element.

11. The blocking mechanism of claim 10, wherein the movement mechanism has a screw drive for generating the axial stroke movement.

12. The blocking mechanism of claim 10, wherein the movement mechanism has a plunger coil for generating the axial stroke movement.

13. An electric motor drive unit having a blocking mechanism of claim 1.

14. A vehicle having an electric motor drive unit as claimed in claim 13.

15. A method for blocking a shaft of a drivetrain supported by a vehicle, by a blocking mechanism, the method comprising:
providing a blocking actuator of the drivetrain;
providing a blockable shaft of the drivetrain;
providing a form-fitting element being part of the blocking actuator;
actuating the form-fitting element between the blocking actuator and the blockable shaft, the form-fitting element includes an elastic force transmission portion being integrated in the form-fitting element;
actuating the form-fitting element in an axial stroke movement and longitudinally in relation to the shaft; and
bringing the form-fitting element into latching engagement with the shaft-mounted complement by utilizing the movement clearance, up to a maximum rotational speed of the shaft that depends on the movement clearance, in that the form-fitting element, in a state in which it bears against an end face of the shaft-mounted complement, is biased longitudinally in relation to the shaft and with a definable force against the shaft-mounted complement via the at least one elastic force transmission portion until a latching engagement is obtained.

16. The method of claim 15, wherein when the vehicle starts to move from a stationary position, a shaft of the vehicle is blocked up to a maximum speed of the vehicle that depends on the movement clearance.
